(19) United States
(12) Patent Application Publication
(10) Pub. No.: US 2026/0261988 A1
(43) Pub. Date: Sep. 3, 2026

(54) METHOD FOR SOUNDING REFERENCE SIGNAL TRANSMISSION FOR USER EQUIPMENT CROSS-LINK INTERFERENCE MEASUREMENT IN MOBILE COMMUNICATIONS

(71) Applicant: MediaTek Singapore Pte. Ltd., Singapore (SG)

(72) Inventors: Sumaila Anning MAHAMA, Cambridge (GB); Mohammed S Aleabe AL-IMARI, Cambridge (GB); Jozsef Gabor NEMETH, Cambridge (GB)

(73) Assignee: MediaTek Singapore Pte. Ltd., Singapore (SG)

(21) Appl. No.: 19/474,208

(22) PCT Filed: Aug. 8, 2024
(86) PCT No.: PCT/CN2024/110644

§ 371 Date: Oct. 10, 2025

Related U.S. Application Data
(60) Provisional application No. 63/518,951, filed on Aug. 11, 2023.

(51) Int. Cl. H04W 52/32; H04L 5/00; H04W 52/24; H04W 52/36

(52) U.S. Cl. CPC H04W 52/325; H04L 5/0051; H04L 5/0073; H04W 52/243; H04W 52/367

(57) ABSTRACT

Various solutions for sounding reference signal (SRS) transmission for user equipment (UE) cross-link interference (CLI) measurement with respect to an apparatus in mobile communications are described. The apparatus may receive a power configuration of an SRS resource set associated with an inter-UE CLI measurement. The apparatus may transmit an SRS to a UE based on a first power according to the power configuration of the SRS resource set for determining the inter-UE CLI measurement.

### CROSS REFERENCE TO RELATED PATENT APPLICATION(S)

The present disclosure is part of a non-provisional application claiming the priority benefit of U.S. Patent Application No. 63/518,951, filed 11 Aug. 2023, the content of which herein being incorporated by reference in its entirety.

### TECHNICAL FIELD

The present disclosure is generally related to mobile communications and, more particularly, to sounding reference signal transmission for user equipment cross-link interference measurement with respect to apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR) mobile communications, technology of sounding reference signal (SRS) is introduced. Generally, SRS may be transmitted from a user equipment (UE) to assist a base station (e.g., eNodeB in LTE or gNodeB in NR) in estimating the channel quality between the base station and the UE. The estimation may be important for efficient resource allocation, scheduling, and beamforming.

In some scenarios, the SRS transmitted to the base station may also be used for one or more UE(s) to estimate the channel quality(s) between the UEs by performing inter-UE cross-link interference (CLI) measurement.

However, the power for transmitting the SRS to the base station may not be appropriate for transmitting the SRS to a nearby UE for inter-UE CLI measurement purpose. Accordingly, how to adjust the power for transmitting the SRS for inter-UE CLI measurement becomes an important issue in the newly developed wireless communication network. Therefore, there is a need to provide proper schemes to adjust the power for transmitting the SRS for inter-UE CLI measurement.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to sounding reference signal (SRS) transmission for user equipment (UE) cross-link interference (CLI) measurement with respect to apparatus in mobile communications.

In one aspect, a method may involve an apparatus receiving a power configuration of an SRS resource set associated with an inter-UE CLI measurement. The method may also involve the apparatus transmitting an SRS to a UE based on a first power according to the power configuration of the SRS resource set for determining the inter-UE CLI measurement.

In one aspect, a method may involve an apparatus determining a power configuration of an SRS resource set associated with an inter-UE CLI measurement. The method may also involve the apparatus transmitting the power configuration of the SRS resource set to a UE for performing the inter-UE CLI measurement based on a first power according to the power configuration of the SRS resource set.

In one aspect, a method may involve an apparatus receiving an SRS from a UE based on a first power associated with a power configuration of an SRS resource set associated with an inter-UE CLI measurement. The method may also involve the apparatus determining the inter-UE CLI measurement according to the SRS. The method may also involve the apparatus adjusting the inter-UE CLI measurement based on a power difference between the first power and a second power associated with an uplink transmission or reporting the inter-UE CLI measurement based on a first threshold. The first threshold may be lower than a second threshold associated with a normal SRS transmission.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to sounding reference signal (SRS) transmission for user equipment (UE) cross-link interference (CLI) measurement with respect to apparatus in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may determine a power configuration of an SRS resource set associated with an inter-UE CLI measurement. Specifically, the inter-UE CLI measurement may be used for measuring interference between UE, and the SRS resource set may be used for performing the inter-UE CLI measurement. Then, the network node may transmit the power configuration to a first UE. After receiving the power configuration of the SRS resource set, the first UE may apply the power configuration and utilize the SRS resource set for the inter-UE CLI measurement.

More specifically, the first UE may transmit an SRS, which is determined from the SRS resource set used for the inter-UE CLI measurement, to a second UE based on a first power according to the power configuration of the SRS resource set. In other words, the first UE may use the first power to transmit the SRS to the second UE according to the power configuration. Accordingly, the second UE may determine the inter-UE CLI measurement according to the SRS transmitted from the first UE (i.e., the second UE may measure the SRS for determining the inter-UE CLI measurement).

Based on the presence of the SRS resource set dedicated to the inter-UE CLI measurement, parameters (e.g., transmitting power, antenna port, SRS periodicity, etc.) associated with the SRS resource set may be different from parameters associated with a regular SRS resource set which is used for a regular SRS transmission between the UEs and the network node. Therefore, performing SRS procedure between UEs may be significantly more efficient and appropriate.

For example, unlike a second power used to transmit an SRS between the network node and the first UE, the first power for transmitting an SRS between the first UE and the second UE can be adjusted to be much lower than the second power when the first UE and the second UE are close. The adjustment may significantly save energy.

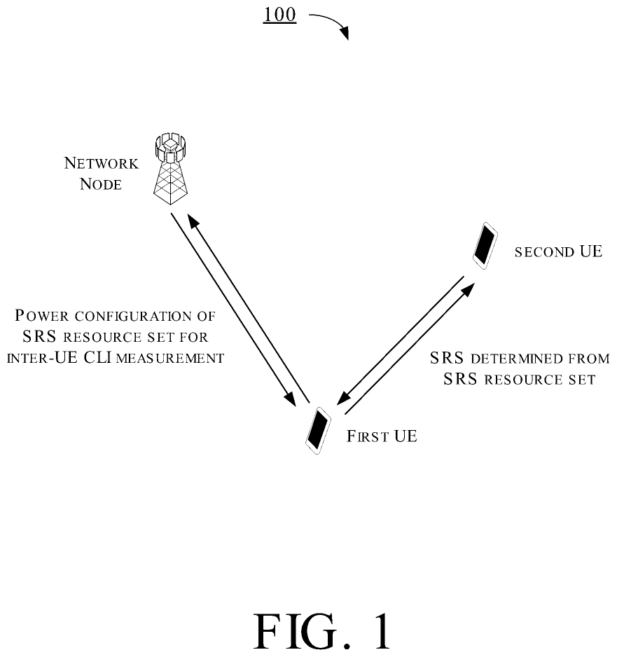

FIG. 1 illustrates an example scenario 100 under schemes in accordance with implementations of the present disclosure. Scenario 100 involves at least one network node, a first UE and a second UE, which may be a part of a wireless communication network (e.g., an LTE network, a 5G/NR network, an IoT network or a 6G network). Scenario 100 illustrates the current network framework. The first UE and the second UE may connect to the network side. The network side may comprise one or more than one network nodes.

In some embodiments, the network node may determine a power configuration of an SRS resource set associated with an inter-UE CLI measurement. Specifically, the SRS resource set may be used for the inter-UE CLI measurement, and the power configuration may be used for determining a power for transmitting an SRS for the inter-UE CLI measurement. The network node may transmit the power configuration of the SRS resource set to the first UE. In some implementations, the power configuration of the SRS resource set may be included in a higher layer signaling (e.g., radio resource control (RRC) configuration).

Then, the first UE may receive the power configuration of the SRS resource set which is used for the inter-UE CLI measurement. The first UE may determine a first power according to the power configuration of the SRS resource set. Accordingly, the first UE may determine an SRS according to the SRS resource set and transmit the determined SRS to the second UE based on the first power for the second UE to determine the inter-UE CLI measurement. In other words, the second UE may measure inter-UE CLI between the first UE and the second UE according to the SRS transmitted with the first power from the first UE.

In some embodiments, the first power may be lower than a second power which is used for transmitting another SRS to the network node. Specifically, regarding a regular SRS resource set (i.e., an SRS resource set associated with SRS transmission to the network node), the first UE may determine the second power for transmitting a regular SRS to the network node. In some implementations, the first power may be set lower than the second power because: (1) the first power may be used for transmitting the SRS to the nearby second UE; and (2) the second power may be used for transmitting the regular SRS to the far network node.

In some embodiments, the power configuration of the SRS resource set associated with the inter-UE CLI measurement may be enabled or disabled. Specifically, the power configuration may include a parameter indicating whether the power configuration is enabled or disabled. In some implementations, the parameter may include a Boolean value indicating whether the power configuration is enabled or disabled. In some implementations, the presence of the parameter in the power configuration may indicate whether the power configuration is enabled or disabled. In some implementations, the power configuration may always be enabled if the SRS resource set associated with the inter-UE CLI measurement is configured.

In some embodiments, except the first power, a procedure of transmitting the SRS according to the SRS resource set may be the same as a procedure of transmitting the regular SRS according to the regular SRS resource set. For example, the first UE may assume that the parameter “usage” (defined in 3GPP specification) within “SRS-ResourceSet” (defined in 3GPP specification) is set as “nonCodebook” (defined in 3GPP specification), the parameter “usage” within “SRS-ResourceSet” is set as “Codebook” (defined in 3GPP specification), the parameter “usage” within “SRS-ResourceSet” is set as “beamManagement” (defined in 3GPP specification) or the parameter “usage” within “SRS-ResourceSet” is set as “antennaSwitching” (defined in 3GPP specification) when low power SRS transmission is enabled.

In some embodiments, the first power may be determined as a minimum one of a maximum transmitting power of the first UE and a specific power. In some implementations, the specific power may be determined according to a nominal transmitting power, a number of allocated resource blocks, a fractional power control multiplier, a pathloss and a lower power mode multiplier. The lower power mode multiplier may be used to active or inactive usages of the fractional power control multiplier and the pathloss. In some implementations, the specific power may be determined according to the nominal transmitting power and the number of allocated resource blocks.

For example, the first UE determines the first power on a bandwidth part (BWP) b belonging to a carrier f and a serving cell c during a transmission occasion i using SRS resource set qₛ based on one of the following formulas:

$${P}_{SRS , b , f , c} ( i , {q}_{s} ) = MIN \{ \begin{matrix}\begin{matrix}{P}_{CMax , f , c} ( i ) \\ {P}_{0 \_ SRS , b , f , c} ( {q}_{s} ) + 10 \cdot LOG ( {2}^{μ} \cdot {M}_{SRS , b , f , c} ( i ) ) +\end{matrix} \\ {α}_{LP} \cdot {α}_{SRS , b , f , c} ( {q}_{s} ) \cdot {PL}_{b , f , c} ( {q}_{s} )\end{matrix} \qquad ( 1 )$$

$${P}_{SRS , b , f , c} ( i , {q}_{s} ) = MIN \{ \begin{matrix}{P}_{CMax , f , c} ( i ) \\ {P}_{0 \_ SRS , b , f , c} ( {q}_{s} ) + 10 \cdot LOG ( {2}^{μ} \cdot {M}_{SRS , b , f , c} ( i ) )\end{matrix} \qquad ( 2 )$$

where P_{SRS,b,f,c}(i, qₛ) is the first power, P_{CMax,f,c}(i) is the maximum transmitting power, P_{0_SRS,b,f,c}(qₛ) is the nominal transmitting power, M_{SRS,b,f,c}(i) is the number of allocated resource blocks for subcarrier spacing μ, α_{SRS,b,f,c}(qₛ) is the fractional power control multiplier, PL_{b,f,c}(qₛ) is the pathloss between the first UE and the network node, and app is the low power mode multiplier.

Regarding formula (1), the low power mode multiplier is used to active or inactive usages of the fractional power control multiplier and the pathloss. In other words, the low power mode multiplier is used to determine if the pathloss between the first UE and the network node is omitted from the above formula or not. In some implementations, α_{LP} may have a value of ‘0’ or ‘1’. If α_{LP}=0, it means that the pathloss between the first UE and network node is omitted from the above formula when the power configuration is enabled. If α_{LP}=1, it means that the pathloss between the first UE and the network node is considered in the above formula when the power configuration is enabled. Regarding formula (2), the fractional power control multiplier, the pathloss and the lower power mode multiplier may be directly omitted.

In some embodiments, comparing to legacy formula of power control for SRS transmission, the above formulas of the present disclosure may not include any closed loop power control parameter. More specifically, a closed loop power control parameter h_{b,f,c}(i, l) (defined in 3GPP specification) which represent a power control adjustment state may not be applied in the above formulas.

In some embodiments, the maximum transmitting power may be ranged from a low maximum transmitting power to a high maximum transmitting power. The low maximum transmitting power may be determined according to a value for a low SRS transmitting power.

For example, the range of values from which P_{CMax,f,c}(i) is determined is given by the following formula:

$${P}_{CMax , L , f , c} ( i ) \leq {P}_{CMax , f , c} ( i ) \leq {P}_{CMax , H , f , c} ( i ) \qquad ( 3 )$$

where P_{CMax,f,c}(i) is the maximum transmitting power, P_{CMax,L,f,c}(i) is the low maximum transmitting power, and P_{CMax,H,f,c}(i) is the high maximum transmitting power.

Further, the low maximum transmitting power and the high maximum transmitting power are determined based on the following formulas:

$${P}_{CMax , L , f , c} ( i ) = MIN \{ {P}_{EMax , c} - Δ {T}_{C , c} , ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RxSRS} + Δ {T}_{LpSRS} , P - {MPR}_{c} ) \} \qquad ( 4 )$$

$${P}_{CMax , H , f , c} ( i ) = MIN \{ {P}_{EMax , c} , ( {P}_{PowerClass} - Δ {P}_{PowerClass} ) \} \qquad ( 5 )$$

where P_{EMAX,c} is a value given by p-Max information element (defined in 3GPP specification), P_{PowerClass} is a maximum UE power (defined in 3GPP specification), ΔP_{PowerClass} is class level (defined in 3GPP specification, e.g., 3 dB for a power class 2 capable UE or 3 dB during SRS transmission occasions with “usage” in “SRS-ResourceSet” set as “antennaSwitching”, ΔT_{C,c} and ΔT_{IB,c} are tolerance values (defined in 3GPP specification), MPR_{c},A−MPR_{c} and P−MPR_{c} are respectively maximum power reduction, additional maximum power reduction and power management maximum power reduction values (defined in 3GPP specification), and ΔT_{LpSRS} is the value for the low SRS transmitting power.

In some implementations, ΔT_{LpSRS} is a non-zero value (e.g., a positive value) when the power configuration is enabled. In some implementations, ΔT_{LpSRS} is zero when the power configuration is disabled. In some implementations, ΔP_{PowerClass} is a non-zero value when the power configuration is enabled.

In some implementations, the nominal transmitting power may be configured for a low power SRS transmission (i.e., an SRS transmission associate with the SRS resource set dedicated to the inter-UE CLI measurement). In particular, the nominal transmitting power P_{0_SRS,b,f,c}(qₛ) may be configured with two values, one is for the low power SRS transmission and the other is for the regular SRS transmission. More specifically, when the power configuration is enabled and there is the SRS resource set dedicated for inter-UE CLI measurement, the network node may have the flexibility to configure an appropriate value from the two values of the nominal transmitting power P_{0_SRS,b,f,c}(qₛ) for the low power SRS transmission.

In some implementations, the first power may be multiplied by a fractional parameter for adjusting the first power. For example, when the first power P_{SRS,b,f,c}(i, qₛ) is multiplied by the fractional parameter β. The fractional parameter β is provided with the SRS resource set. The fractional parameter β is greater than 0 and less than or equal to 1 (i.e., 0<β≤1).

In some implementations, the SRS resource set dedicated to the inter-UE CLI measurement may be configured for a specific type of slot.

In some cases, the SRS resource set dedicated to the inter-UE CLI measurement may be configured for partitioned slot(s). In particular, a partitioned slot may be defined as a slot that any symbol of the slot includes both downlink (DL) resource(s) and uplink (UL) resource(s). Otherwise, the slot may be defined as non-partitioned slot.

In some cases, the SRS determined from the SRS resource set dedicated to the inter-UE CLI measurement may be configured to be transmitted on an UL sub-band of a slot. More specifically, the SRS determined from the SRS resource set dedicated to the inter-UE CLI measurement may be configured to be transmitted on an UL sub-band of a sub-band full duplex (SBFD) slot which may include both UL sub-band(s) and DL sub-band(s).

In some cases, the SRS determined from the SRS resource set dedicated to the inter-UE CLI measurement may be configured to be transmitted on a guard band of an SBFD slot. More specifically, the SBFD slot may include UL sub-band(s), DL sub-band(s) and guard band(s), and the SRS determined from the SRS resource set dedicated to the inter-UE CLI measurement may be configured to be transmitted on one of the guard band(s).

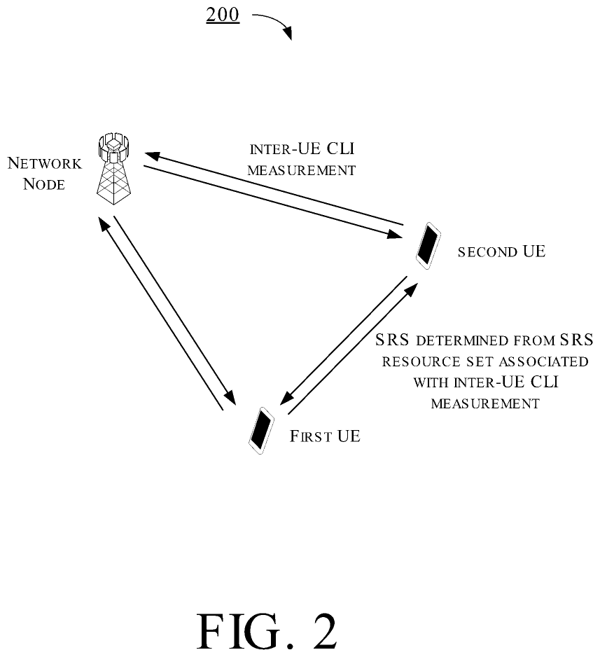

FIG. 2 illustrates an example scenario 200 under schemes in accordance with implementations of the present disclosure. In some embodiments, after the first UE transmits the determined SRS to the second UE based on the first power according to the power configuration (i.e., after the second UE receives the determined SRS based on the first power associated with the power configuration), the second UE may determine the inter-UE CLI measurement (i.e., determine the inter-UE CLI) according to the determined SRS transmitted with the first power from the first UE. Then, the second UE may: (1) adjust the inter-UE CLI measurement based on a power difference between the first power and a second power associated with an uplink transmission; or (2) report the inter-UE CLI measurement based on a first threshold.

More specifically, a measured CLI value may be adjusted to reflect an expected CLI level from the uplink transmission with higher transmitting power. In some cases, the inter-UE CLI measurement may be adjusted to compensate for the power difference between the low power (i.e., the first power) for transmitting the determined SRS and the higher power (i.e., the second power associated with the uplink transmission) for the uplink transmission from some uplink channels (e.g., physical uplink share channel (PUSCH), physical uplink control channel (PUCCH), SRS channel and physical random access channel (PRACH)).

In some implementations, a function of adjusting the inter-UE CLI measurement may be enabled or disabled.

In some implementations, the inter-UE CLI measurement may be multiplied by a scaling factor. The scaling factor may be selected such that a CLI level of the adjusted inter-UE CLI measurement may correspond to an expected CLI level of the uplink transmission with higher power.

In some implementations, the scaling factor may be selected or configured separately for each SRS measurement resource. For example, the scaling factor is selected or configured to enable measurement of a regular SRS transmission (with higher power) and an SRS transmission (with lower power) dedicated to the inter-UE CLI measurement simultaneously).

In some implementations, an event triggered CLI reporting may be triggered when the CLI level of the adjusted inter-UE CLI measurement is above a pre-defined threshold for triggering a report. In some cases, a separate SRS-reference symbol received power (RSRP) reporting range and/or an SRS-RSRP measurement report mapping may be defined for the SRS transmission (with lower power) dedicated to the inter-UE CLI measurement.

In some implementations, the first threshold may be configured for an event triggered CLI reporting. SRS-RSRP reporting may be triggered by the first threshold which is lower than the second threshold used for an SRS-RSRP reporting associated with the regular SRS transmission.

In some implementations, the network node may have the flexibility to configure the first threshold when the second UE is configured to report the inter-UE CLI measurement based on the SRS transmission dedicated to the inter-UE CLI measurement.

In some implementations, the first threshold for the SRS transmission dedicated to the inter-UE CLI measurement may be selected based on the measured CLI value.

In some implementations, the second UE may be configured with a look-up table including relations between a plurality of thresholds and a plurality of CLI values. The second UE may select a threshold from the look-up table based on a corresponding CLI value.

### Illustrative Implementations

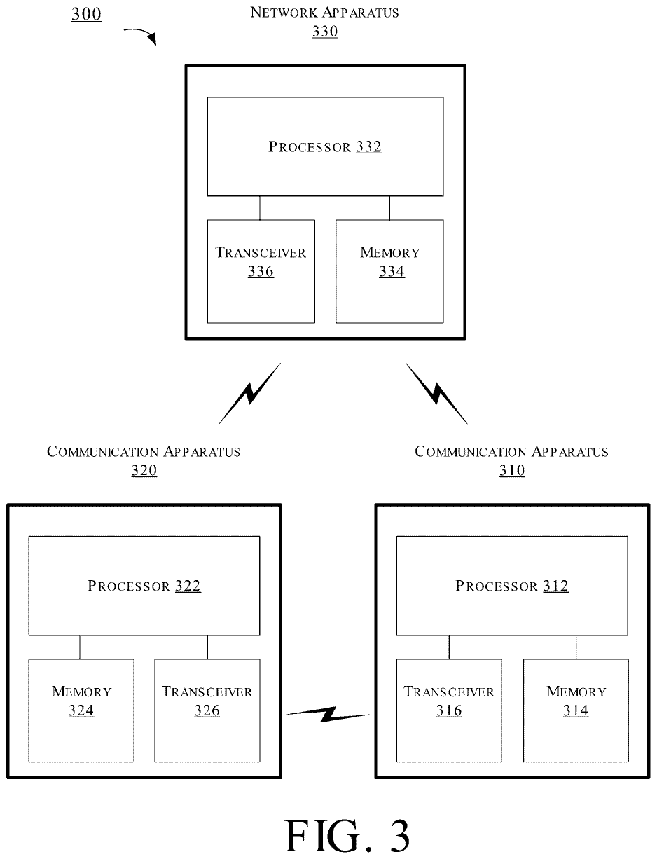

FIG. 3 illustrates an example communication system 300 having an example communication apparatus 310, an example communication apparatus 320, and an example network apparatus 330 in accordance with an implementation of the present disclosure. Each of communication apparatus 310, communication apparatus 320 and network apparatus 330 may perform various functions to implement schemes, techniques, processes and methods described herein pertaining to SRS transmission for UE CLI measurement in mobile communications, including scenarios/schemes described above as well as process 400, process 500 and process 600 described below.

Communication apparatus 310/320 may be a part of an electronic apparatus, which may be a UE such as a portable or mobile apparatus, a wearable apparatus, a mobile communication apparatus or a computing apparatus. For instance, communication apparatus 310/320 may be implemented in a smartphone, a smartwatch, a personal digital assistant, a digital camera, or a computing equipment such as a tablet computer, a laptop computer or a notebook computer. Communication apparatus 310/320 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310/320 may be implemented in a smart thermostat, a smart fridge, a smart door lock, a wireless speaker or a home control center. Alternatively, communication apparatus 310/320 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310/320 may include at least some of those components shown in FIG. 3 such as a processor 312/322, for example. Communication apparatus 310/320 may further include one or more other components not pertinent to the proposed scheme of the present disclosure (e.g., internal power supply, display device and/or user interface device), and, thus, such component(s) of communication apparatus 310/320 are neither shown in FIG. 3 nor described below in the interest of simplicity and brevity.

Network apparatus 330 may be a part of a network device, which may be a network node such as a satellite, a base station, a small cell, a router or a gateway. For instance, network apparatus 330 may be implemented in an eNodeB in an LTE network, in a gNB in a 5G/NR, IoT, NB-IoT or IIoT network or in a satellite or base station in a 6G network. Alternatively, network apparatus 330 may be implemented in the form of one or more IC chips such as, for example and without limitation, one or more single-core processors, one or more multi-core processors, or one or more RISC or CISC processors. Network apparatus 330 may include at least some of those components shown in FIG. 3 such as a processor 332, for example. Network apparatus 330 may further include one or more other components not pertinent to the proposed scheme of the present disclosure (e.g., internal power supply, display device and/or user interface device), and, thus, such component(s) of network apparatus 330 are neither shown in FIG. 3 nor described below in the interest of simplicity and brevity.

In one aspect, each of processor 312, processor 322 and processor 332 may be implemented in the form of one or more single-core processors, one or more multi-core processors, or one or more CISC processors. That is, even though a singular term “a processor” is used herein to refer to processor 312, processor 322 and processor 332, each of processor 312, processor 322 and processor 332 may include multiple processors in some implementations and a single processor in other implementations in accordance with the present disclosure. In another aspect, each of processor 312, processor 322 and processor 332 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312, processor 322 and processor 332 is a special-purpose machine specifically designed, arranged and configured to perform specific tasks including SRS transmission for UE CLI measurement in a device (e.g., as represented by communication apparatus 310 and communication apparatus 320) and a network (e.g., as represented by network apparatus 330) in accordance with various implementations of the present disclosure.

In some implementations, communication apparatus 310 may also include a transceiver 316 coupled to processor 312 and capable of wirelessly transmitting and receiving data. In other words, processor 312 may transceive the data such as configuration, message, signal, information, indicator, etc. via transceiver 316. In some implementations, communication apparatus 310 may further include a memory 314 coupled to processor 312 and capable of being accessed by processor 312 and storing data therein. In some implementations, communication apparatus 320 may also include a transceiver 326 coupled to processor 322 and capable of wirelessly transmitting and receiving data. In other words, processor 322 may transceive the data such as configuration, message, signal, information, indicator, etc. via transceiver 326. In some implementations, communication apparatus 320 may further include a memory 324 coupled to processor 322 and capable of being accessed by processor 322 and storing data therein. In some implementations, network apparatus 330 may also include a transceiver 336 coupled to processor 332 and capable of wirelessly transmitting and receiving data. In other words, processor 332 may transceive the data such as configuration, message, signal, information, indicator, etc. via transceiver 336. In some implementations, network apparatus 330 may further include a memory 334 coupled to processor 332 and capable of being accessed by processor 332 and storing data therein. Accordingly, communication apparatus 310, communication apparatus 320 and network apparatus 330 may wirelessly communicate with each other via transceiver 316, transceiver 326 and transceiver 336, respectively. To aid better understanding, the following description of the operations, functionalities and capabilities of each of communication apparatus 310, 320 and network apparatus 330 is provided in the context of a mobile communication environment in which communication apparatus 310, 320 are implemented in or as communication apparatuses or UEs and network apparatus 330 is implemented in or as a network node of a communication network.

In some implementations, each of memory 314, memory 324 and memory 334 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314, memory 324 and memory 334 may include a type of read-only memory (ROM) such as mask ROM, programmable ROM (PROM), erasable programmable ROM (EPROM) and/or electrically erasable programmable ROM (EEPROM). Alternatively, or additionally, each of memory 314, memory 324 and memory 334 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

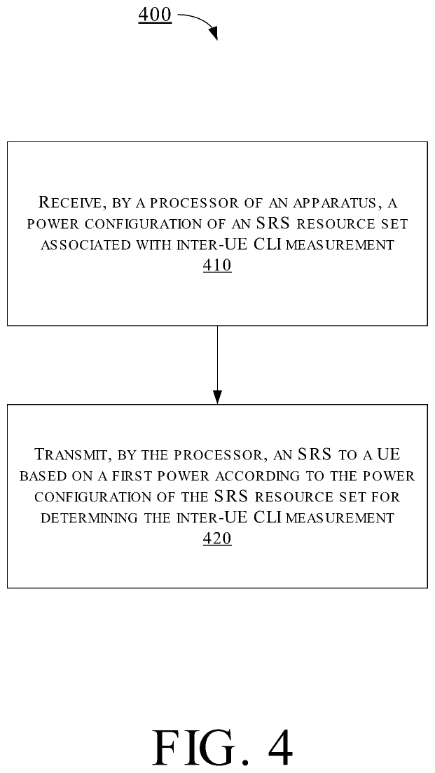

FIG. 4 illustrates an example process 400 in accordance with an implementation of the present disclosure. Process 400 may be an example implementation of above scenarios/schemes, whether partially or completely, with respect to SRS transmission for UE CLI measurement of the present disclosure. Process 400 may represent an aspect of implementation of features of communication apparatus 310. Process 400 may include one or more operations, actions, or functions as illustrated by one or more of blocks 410 to 420. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At block 410, process 400 may involve processor 312 of communication apparatus 310 receiving a power configuration of an SRS resource set associated with an inter-UE CLI measurement. Process 400 may proceed from block 410 to block 420.

At block 420, process 400 may involve processor 312 of communication apparatus 310 transmitting an SRS to a UE based on a first power according to the power configuration of the SRS resource set for determining the inter-UE CLI measurement.

In some implementations, process 400 may involve processor 312 of communication apparatus 310 determining the first power according to the power configuration of the SRS resource set.

In some implementations, the first power is determined as a minimum one of a maximum transmitting power of the apparatus and a specific power, and the specific power is determined according to a nominal transmitting power and a number of allocated resource blocks.

In some implementations, the specific power is determined without a closed loop power control parameter.

In some implementations, the specific power is determined according to the nominal transmitting power, the number of allocated resource blocks, a fractional power control multiplier, a pathloss and a lower power mode multiplier which is used to active or inactive usages of the fractional power control multiplier and the pathloss.

In some implementations, the maximum transmitting power is ranged from a low maximum transmitting power to a high maximum transmitting power, and the low maximum transmitting power is determined according to a value for a low SRS transmitting power.

In some implementations, the nominal transmitting power is configured for a low power SRS transmission.

In some implementations, the first power is multiplied by a fractional parameter.

In some implementations, the first power is lower than a second power which is used for transmitting another SRS to a network node.

In some implementations, the SRS resource set is configured for a specific type of slot.

In some implementations, the specific type of slot includes an SBFD slot.
the SRS is configured to be transmitted on a guard band of an SBFD slot.

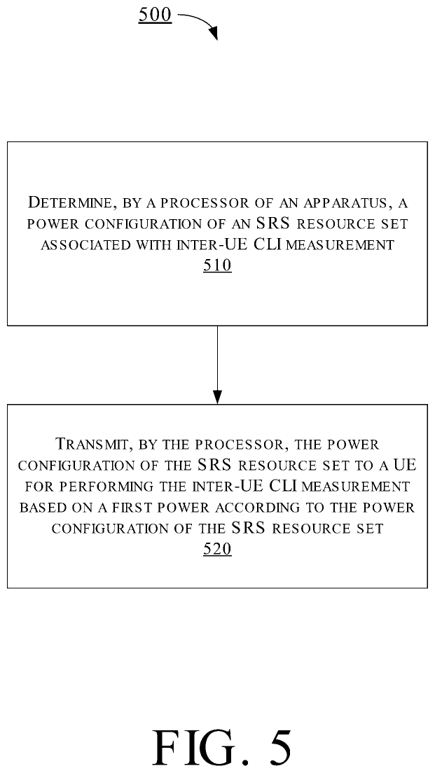

FIG. 5 illustrates an example process 500 in accordance with an implementation of the present disclosure. Process 500 may be an example implementation of above scenarios/schemes, whether partially or completely, with respect to SRS transmission for UE CLI measurement of the present disclosure. Process 500 may represent an aspect of implementation of features of network apparatus 330. Process 500 may include one or more operations, actions, or functions as illustrated by one or more of blocks 510 to 520. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by network apparatus 330 or any suitable network device or machine type devices. Solely for illustrative purposes and without limitation, process 500 is described below in the context of network apparatus 330. Process 500 may begin at block 510.

At block 510, process 500 may involve processor 332 of network apparatus 330 determining a power configuration of an SRS resource set associated with an inter-UE CLI measurement. Process 500 may proceed from block 510 to block 520.

At block 520, process 500 may involve processor 332 of network apparatus 330 transmitting the power configuration of the SRS resource set to a UE for performing the inter-UE CLI measurement based on a first power according to the power configuration of the SRS resource set.

In some implementations, the first power is lower than a second power associated with an SRS transmission from the UE.

In some implementations, the SRS resource set is configured for a specific type of slot.

In some implementations, the specific type of slot includes an SBFD slot.

In some implementations, an SRS for performing the inter-UE CLI measurement is configured to be transmitted on a guard band of an SBFD slot.

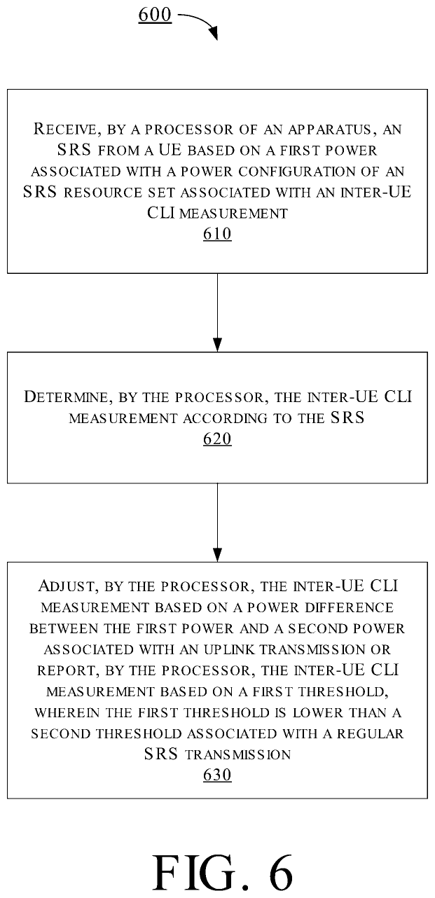

FIG. 6 illustrates an example process 600 in accordance with an implementation of the present disclosure. Process 600 may be an example implementation of above scenarios/schemes, whether partially or completely, with respect to SRS transmission for UE CLI measurement of the present disclosure. Process 600 may represent an aspect of implementation of features of communication apparatus 320. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 320 or any suitable UE or machine type devices. Solely for illustrative purposes and without limitation, process 600 is described below in the context of communication apparatus 320. Process 600 may begin at block 610.

At block 610, process 600 may involve processor 322 of communication apparatus 320 receiving an SRS from a UE based on a first power associated with a power configuration of an SRS resource set associated with an inter-UE CLI measurement. Process 600 may proceed from block 610 to block 620.

At block 620, process 600 may involve processor 322 of communication apparatus 320 determining the inter-UE CLI measurement according to the SRS. Process 600 may proceed from block 610 to block 620.

At block 630, process 600 may involve processor 322 of communication apparatus 320: (1) adjusting the inter-UE CLI measurement based on a power difference between the first power and a second power associated with an uplink transmission; or (2) reporting the inter-UE CLI measurement based on a first threshold. The first threshold is lower than a second threshold associated with a regular SRS transmission.

In some implementations, process 600 may involve processor 322 of communication apparatus 320 adjusting the inter-UE CLI measurement by a scaling factor based on the power difference between the first power and the second power associated with the uplink transmission.

In some implementations, the first threshold is determined based on a look-up table including relations between a plurality of thresholds and a plurality of CLI values.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a power configuration of a sounding reference signal (SRS) resource set associated with an inter-user equipment (UE) cross-link interference (CLI) measurement; and
transmitting, by the processor, an SRS to a UE based on a first power according to the power configuration of the SRS resource set for determining the inter-UE CLI measurement.

2. The method of claim 1, further comprising:
determining, by the processor, the first power according to the power configuration of the SRS resource set.

3. The method of claim 2, wherein the first power is determined as a minimum one of a maximum transmitting power of the apparatus and a specific power, and the specific power is determined according to a nominal transmitting power and a number of allocated resource blocks.

4. The method of claim 3, wherein the specific power is determined without a closed loop power control parameter.

5. The method of claim 3, wherein the specific power is determined according to the nominal transmitting power, the number of allocated resource blocks, a fractional power control multiplier, a pathloss and a lower power mode multiplier which is used to active or inactive usages of the fractional power control multiplier and the pathloss.

6. The method of claim 3, wherein the maximum transmitting power is ranged from a low maximum transmitting power to a high maximum transmitting power, and the low maximum transmitting power is determined according to a value for a low SRS transmitting power.

7. The method of claim 3, wherein the nominal transmitting power is configured for a low power SRS transmission.

8. The method of claim 2, wherein the first power is multiplied by a fractional parameter.

9. The method of claim 1, wherein the first power is lower than a second power which is used for transmitting another SRS to a network node.

10. The method of claim 1 wherein the SRS resource set is configured for a specific type of slot.

11. The method of claim 10, wherein the specific type of slot includes a sub-band full duplex (SBFD) slot.

12. The method of claim 1, wherein the SRS is configured to be transmitted on a guard band of a sub-band full duplex (SBFD) slot.

13. A method, comprising:
determining, by a processor of an apparatus, a power configuration of a sounding reference signal (SRS) resource set associated with an inter-user equipment (UE) cross-link interference (CLI) measurement; and
transmitting, by the processor, the power configuration of the SRS resource set to a UE for performing the inter-UE CLI measurement based on a first power according to the power configuration of the SRS resource set.

14. The method of claim 13, wherein the first power is lower than a second power associated with an SRS transmission from the UE.

15. The method of claim 13, wherein the SRS resource set is configured for a specific type of slot.

16. The method of claim 15, wherein the specific type of slot includes a sub-band full duplex (SBFD) slot.

17. The method of claim 13, wherein an SRS for performing the inter-UE CLI measurement is configured to be transmitted on a guard band of a sub-band full duplex (SBFD) slot.

18. A method, comprising:
receiving, by a processor of an apparatus, a sounding reference signal (SRS) from a UE based on a first power associated with a power configuration of an SRS resource set associated with an inter-user equipment (UE) cross-link interference (CLI) measurement;
determining, by the processor, the inter-UE CLI measurement according to the SRS; and
adjusting, by the processor, the inter-UE CLI measurement based on a power difference between the first power and a second power associated with an uplink transmission or reporting, by the processor, the inter-UE CLI measurement based on a first threshold, wherein the first threshold is lower than a second threshold associated with a regular SRS transmission.

19. The method of claim 18, wherein the step of adjusting the inter-UE CLI measurement based on the power difference between the first power and a second power associated with an uplink transmission further comprises:
adjusting, by the processor, the inter-UE CLI measurement by a scaling factor based on the power difference between the first power and the second power associated with the uplink transmission.

20. The method of claim 18, wherein the first threshold is determined based on a look-up table including relations between a plurality of thresholds and a plurality of CLI values.
